(19) United States
(12) Patent Application Publication
(10) Pub. No.: US 2025/0226422 A1
(43) Pub. Date: Jul. 10, 2025

(54) MESH FOR AN ELECTRODE OF A LEAD-ACID BATTERY

(71) Applicant: HOPPECKE BATTERIEN GMBH & CO. KG, Brilon (DE)

(72) Inventors: Eduardo CATTANEO, Brilon (DE); Götz LANGER, Brilon (DE); Cora STEIGER, Brilon (DE)

(21) Appl. No.: 18/853,493

(22) PCT Filed: Apr. 6, 2022
(86) PCT No.: PCT/EP2022/059156

§ 371 Date: Oct. 2, 2024

(51) Int. Cl. H01M 4/74; H01M 10/06

(52) U.S. Cl. CPC H01M 4/74; H01M 10/06

(57) ABSTRACT

The disclosure relates to a mesh for an electrode of a lead-acid battery, having a plurality of longitudinal ribs arranged spaced apart from one another in the transverse direction and having a plurality of transverse ribs arranged between two respective adjacent longitudinal ribs and connected thereto, which longitudinal and transverse ribs form a mesh pattern with open areas for receiving an active substance, wherein the longitudinal ribs have a first maximum width in the transverse direction at least in one section running in the longitudinal direction, which is formed in an optimised manner with respect to the total receiving volume provided by the open areas for receiving the active substance, wherein at least one further longitudinal rib is provided, which has a second, maximum width over its entire longitudinal extent in the transverse direction, said width exceeding the first, maximum width of the other longitudinal ribs.

### CROSS-REFERENCE TO RELATED APPLICATIONS

This application is a U.S. National Phase Application under 35 U.S.C. 371 of International Application No. PCT/EP2022/059156, filed on Apr. 6, 2022.

### FIELD

The disclosure relates to a mesh for an electrode of a lead-acid battery, having a plurality of longitudinal ribs arranged spaced apart from one another in the transverse direction and having a plurality of transverse ribs arranged between two respective adjacent longitudinal ribs and connected thereto, which longitudinal and transverse ribs form a mesh pattern with open areas for receiving an active substance, wherein the longitudinal ribs have a first, maximum width in the transverse direction at least in one section running in the longitudinal direction, which width is formed in an optimized manner with respect to the total receiving volume provided by the open areas for receiving the active substance.

### BACKGROUND

This section provides background information related to the present disclosure which is not necessarily prior art.

Meshes for electrodes in general and meshes for electrodes of a positive pole plate of a lead-acid battery in particular are well known in prior art. For this reason, no separate written proof is required at this point and reference is only made to DE 696 22 312 T2 and DE 698 11 939 T2 as an example, which disclose such meshes. DE 698 11 939 T2 relates to a stamped battery plate mesh, whereas DE 696 22 312 T2 relates to a battery mesh produced in a continuous casting process.

A mesh according to this type has a plurality of longitudinal ribs. These extend in the longitudinal direction of the mesh and are arranged spaced from another while leaving a gap space in the transverse direction.

Furthermore, transverse ribs are provided which extend in the transverse direction and which are arranged between two adjacent longitudinal ribs and are connected to them.

When combined, these longitudinal and transverse ribs form a mesh pattern which has window-like, preferably rectangular open areas which serve to receive an active substance.

In the finally assembled state of an electrode, an active substance is introduced into the open areas provided by the mesh, the mesh inclusive of the active substance received by it being covered by a separator permeable to an electrolyte.

The mesh is formed from an electrically conducting material, which material is lead in the case of a lead-acid battery. A metal oxide, such as MnO₂, PbO₂, NiOOH, HgO and Ag₂O, for example, can be used as an active substance for a positive pole electrode, whereas the active substance of a negative pole electrode is formed from a metal such as Zn, Cd, Pb and Sn, for example. However, the disclosure is not limited to the above-mentioned materials, but comprises all materials which can act electrochemically.

The aim generally is to maximize the total receiving volume provided by the open areas of the mesh for receiving the active substance, so that as much active substance as possible can be received by the mesh in relation to the passive substance of the mesh material. This is why the longitudinal ribs should be formed as thin as possible in the transverse direction. Nevertheless, a sufficient service life must be ensured and a desired current collection enabled when used as intended. For this reason, meshes of the described type have longitudinal ribs which are optimized in terms of their geometric design in the transverse direction, i.e. longitudinal ribs, which have a first, maximum width in the transverse direction at least in one section running in the longitudinal direction, which width is designed in an optimized manner with respect to the total receiving volume provided by the open areas for receiving the active substance. This width is about 1.6 mm, for example.

Although meshes that are already known from prior art have proven themselves in everyday practical use, there is room for improvement. For example, corrosion occurring when the meshes are used as intended causes growth of the meshes of a positive pole electrode. Such growth causes the positive pole electrode to expand, in particular in the longitudinal and transverse directions. This expansion of the electrode may be in a range of 15% and more of its original extent in the longitudinal and transverse directions. This can in turn lead to the active substance being torn off the longitudinal and transverse ribs of the mesh, which can result in a loss of battery capacity when the battery is used as intended.

To counter this problem, in particular the longitudinal ribs of the mesh can be reinforced, i.e. have a width in the transverse direction that exceeds the width which is optimized for a maximized receiving volume for receiving the active substance. However, such reinforcement of the longitudinal ribs has the disadvantage that the receiving volume provided by the mesh for receiving the active substance, also referred to as empty volume, decreases with the consequence that a reduced capacity is given when used as intended. In this respect, there are two conflicting interests.

### SUMMARY

This section provides a general summary of the disclosure, and is not a comprehensive disclosure of its full scope or all of its features.

Based on the above-described prior art, it is an object of the disclosure to further develop a mesh of this type to the effect that reduced mesh growth is constructively ensured, while maximizing the receiving volume for receiving the active substance.

To achieve this object, the disclosure proposes a mesh of the initially mentioned type which is characterized by at least one further longitudinal rib which has a second, maximum width in the transverse direction over its entire longitudinal extension, which second, maximum width exceeds the first, maximum width of the other longitudinal ribs.

Consequently, the mesh according to the disclosure comprises two types of longitudinal ribs. In accordance with prior art, longitudinal ribs are provided on the one hand, which have a first, maximum width in the transverse direction at least in a section running in the longitudinal direction, which width is designed in an optimized manner with respect to the total receiving volume provided by the open areas for receiving the active substance. According to the disclosure, at least one further longitudinal rib is provided. This longitudinal rib has a second, maximum width in the transverse direction over its entire longitudinal extension, which exceeds the first, maximal width of the other longitudinal ribs.

When used as intended, the occurrence of corrosion cannot be avoided. As a result of this corrosion, lead oxide is formed on the mesh ribs and thus also on the longitudinal ribs of the mesh. The molar volume of lead oxide is much larger than that of lead which the mesh ribs are formed from. This additional volume with respect to lead oxide leads to shearing and tensile stresses occurring in particular in the longitudinal ribs. This force application causes the mesh to grow, i.e. the mesh expands over time. Such an expansion is disadvantageous for several reasons. On the one hand, the open areas provided by the mesh and accommodating the active substance provided by the mesh increase in size. This can lead to contact breakage of the active mass and individual mesh ribs, which has a detrimental effect on the capacity of a battery equipped with such a mesh.

Furthermore, the mesh growth caused by corrosion can adversely lead to the fact that individual longitudinal or transverse ribs break through the separator covering the mesh, which can then lead undesirable short circuits.

The design according to the disclosure is able to prevent such undesirable mesh growth or at least limit it to a range below 5% in relation to the original geometric design of the mesh. Not all longitudinal ribs are reinforced, i.e. they deviate from the width optimized for maximizing the receiving volume for the active substance. Instead, at least only one longitudinal rib is reinforced.

As has been shown, undesired mesh growth can already be effectively prevented in that not every longitudinal rib of the mesh is reinforced, but only some, or at least one. This takes account of the conflicting interests, i.e. minimizing mesh growth by means of a reinforced longitudinal rib on the one hand and maximizing the receiving volume for the active substance by means of a correspondingly adapted width design of the remaining longitudinal ribs on the other. The result of the design according to the disclosure is a mesh which, due to the at least one further longitudinal rib, has reduced mesh growth compared to the state of the art when used as intended, but which at the same time also provides a maximum empty volume for receiving the active substance.

According to a further feature of the disclosure it is provided that the second, maximum width exceeds the first, maximum width by 20% to 35%, preferably by 25% to 30%, even more preferably by 27.5%. With such width ratios, the design is further optimized with regard to reduced mesh growth on the one hand and maximization of the receiving volume for receiving the active substance on the other.

According to a further feature of the disclosure it is provided that the first, maximum width is 1.4 mm to 1.8 mm, preferably 1.5 mm to 1.7 mm, even more preferably 1.6 mm. The first, maximum width has to be designed for a maximized receiving volume for the active substance, maximized service life, and optimized current collection. For this reason, the disclosure proposes the above-mentioned width dimensions. According to a particular embodiment of the disclosure, the first, maximum width is 1.62 mm.

According to a further feature of the disclosure it is provided that the second, maximum width is 1.8 mm to 2.2 mm, preferably 1.9 mm to 2.1 mm, even more preferably 2.0 mm. Differently from the first, maximum width, the second, maximum width has to be designed in such a way that a reinforcement of the mesh is obtained in such a way that no undesired mesh growth occurs when used as intended and that mesh growth is limited to at least 5% in relation to the original geometric dimensions. This can be achieved with the above-stated width dimensions, wherein, according to a particularly preferred example, a second, maximum width of 2.06 mm is given.

According to a further feature of the disclosure it is provided that not only one further longitudinal rib is provided, but a plurality of further longitudinal ribs with a second, maximum width in the transverse direction. The exact number of the further longitudinal ribs depends in particular on the extension of the mesh in the transverse direction and the forces to be expected on the mesh when it is used as intended, which cause it to expand. With the given dimensions for the second, maximum width, the total number of additional longitudinal ribs to be provided must be selected in such a way that the force applied to the mesh during the intended use can be compensated for to the extent that mesh growth is limited to less than 5%.

According to a further feature of the disclosure it is provided in this context that in the transverse direction of the mesh, every third to fifth, preferably every fourth longitudinal rib is a further longitudinal rib that has a second, maximum width in the transverse direction. Consequently, a mesh according to the disclosure preferably comprises three longitudinal ribs arranged one after the other in the transverse direction, followed by a further longitudinal rib, i.e. a longitudinal rib which has a second, maximum width in the transverse direction. It has been shown that such a sequence of longitudinal ribs achieves an optimized result with regard to reduced growth when used as intended and to the receiving capacity for active substance.

According to a further feature of the disclosure it is provided that the longitudinal ribs have a width in the transverse direction in a second section running in the longitudinal direction, which corresponds to the second, maximum width of the further longitudinal rib.

According to this particular embodiment, which is protectable for itself, the longitudinal ribs not only have a first section, in which they have a first, maximum width in the transverse direction, but additionally a second section, in which they have a width in the transverse direction that corresponds to the second, maximum width of the further longitudinal ribs. Accordingly, the further longitudinal ribs are designed equally wide over their entire longitudinal extension, wherein the remaining longitudinal ribs each have sections with different width designs.

The second sections of the longitudinal ribs are preferably formed on the current collection side, because this is where the most severe corrosion occurs when used as intended. This design measure also minimizes mesh growth that occurs during use as intended.

According to a further feature of the disclosure it is provided that the longitudinal ribs have a width in the transverse direction in a third section running in a longitudinal direction between the first and the second section, which width continuously tapers from the second, maximum width to a third, maximum width. Accordingly, it is provided that the longitudinal ribs have a section at one end, preferably at the current collection end, in which the longitudinal ribs present a second, maximum width in the transverse direction. Preferably, the width of the longitudinal ribs continuously decreases from this width dimension, i.e. until a third, maximum width larger than the first, maximum width is reached. From here, the width dimension further decreases in the longitudinal direction of the longitudinal rib, namely preferably suddenly, and this down to the first, maximum width. Alternatively, a continuous tapering is also possible here.

Therefore, according to the preferred embodiment of the disclosure, the width dimension of a longitudinal rib continuously decreases from the second, maximum width until a third, maximum width is reached, said third, maximum width exceeding the first, maximum width. The transition from the third, maximum width to the first, maximum width is then abrupt, i.e. not continuous, as is the transition from the second, maximum width to the third, maximum width.

This width progression of the longitudinal ribs, which is proposed in particular, also contributes to optimization regarding reduced mesh growth during the intended use and to maximized receiving capacity for the active substance.

According to a further aspect of the disclosure it is provided that the longitudinal ribs and the further longitudinal rib extend between a first frame web and a second frame web to which they are respectively connected in an integral manner, wherein the second frame web carries a current collector lug. In this way, a preferably one-piece mesh is formed all in all, which comprises all the longitudinal ribs, transverse ribs, frame webs and the current collector lug. According to a further feature of the disclosure, the second sections of the longitudinal ribs connect to the second frame web and the first sections of the longitudinal web connect to the first frame web. In this case, said one longitudinal ribs taper from top to bottom in the longitudinal extension of the mesh, i.e. from the second frame web towards the first frame web. In contrast to this, the further longitudinal ribs each have the second, maximum width in the transverse direction over their entire longitudinal extension. Therefore, they do not taper.

According to a further feature of the disclosure it is provided that the mesh is produced in a continuous casting process. To ensure mold release in this case, the longitudinal ribs and also the further longitudinal ribs each have a trapezoidal cross section.

The use of a continuous casting process is particularly preferred because longitudinal ribs with different geometrical dimensions are provided. A continuous casting process is particularly easy and cost-effective to use with regard to this geometric design.

Alternatively, a manufacture of the mesh in a punching process is also possible, wherein in this case, the longitudinal ribs and the further longitudinal ribs each have a preferably rectangular cross section. Due to the fact that demolding is not necessary, a trapezoidal cross-sectional design can be dispensed with during punching, which also simplifies the punching step.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Further features and advantages of the disclosure become apparent from the following description with reference to the attached drawings in which it is shown by:

FIG. 1 a schematic perspective view of a mesh according to the disclosure;

FIG. 2 a schematic plan view of the mesh of the disclosure according to FIG. 1, from the front;

FIG. 3 a schematic plan view of the mesh of the disclosure according to FIG. 1, from the front, with the section planes drawn in;

FIG. 4 details of the mesh according to the disclosure in a sectional view along section line A-A of FIG. 3;

FIG. 5 details of the mesh according to the disclosure in a sectional view along section line B-B of FIG. 3;

FIG. 6 details of the mesh according to the disclosure in a sectional view along section line C-C of FIG. 3;

FIG. 7 a schematic lateral view of the mesh of the disclosure according to FIG. 3; and

FIG. 8 the mesh of the disclosure in a detailed view according to detail Z of FIG. 7.

Corresponding reference numerals indicate corresponding parts throughout the several views of the drawings.

### DETAILED DESCRIPTION

Example embodiments will now be described more fully with reference to the accompanying drawings.

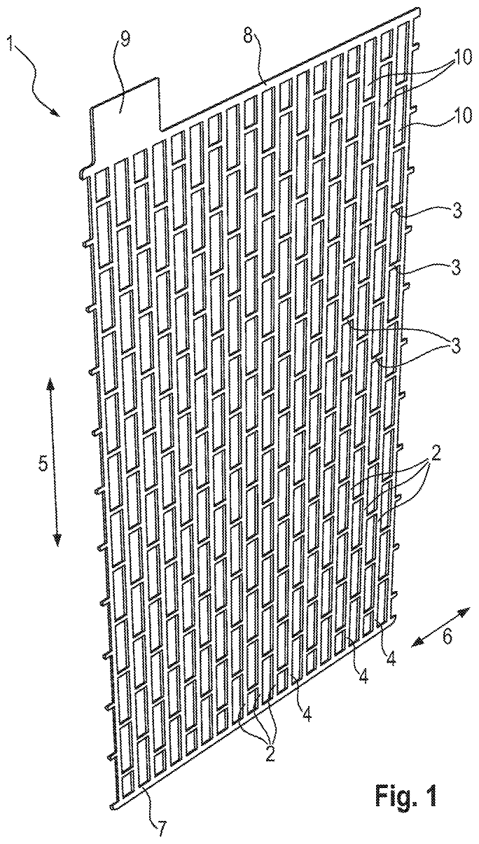

FIG. 1 shows a mesh 1 for an electrode, in particular of a lead-acid battery, in a schematic perspective view.

In the manner known per se, the mesh 1 has a first frame web 7 and a second frame web 8, between which longitudinal ribs 2 or 4 extend. These longitudinal ribs 2 or 4 are arranged spaced from one another in the transverse direction 6.

The mesh 1 further comprises a plurality of transverse ribs 3 respectively arranged between two adjacent longitudinal ribs 2 or 4 and connected thereto.

The longitudinal and transverse ribs 2 or 4 and 3 form a mesh pattern having open areas 10, which open areas 10 serve to receive an active substance.

A current collector lug 9 is also provided, which is arranged on the upper, second frame web 8 in the longitudinal direction 5.

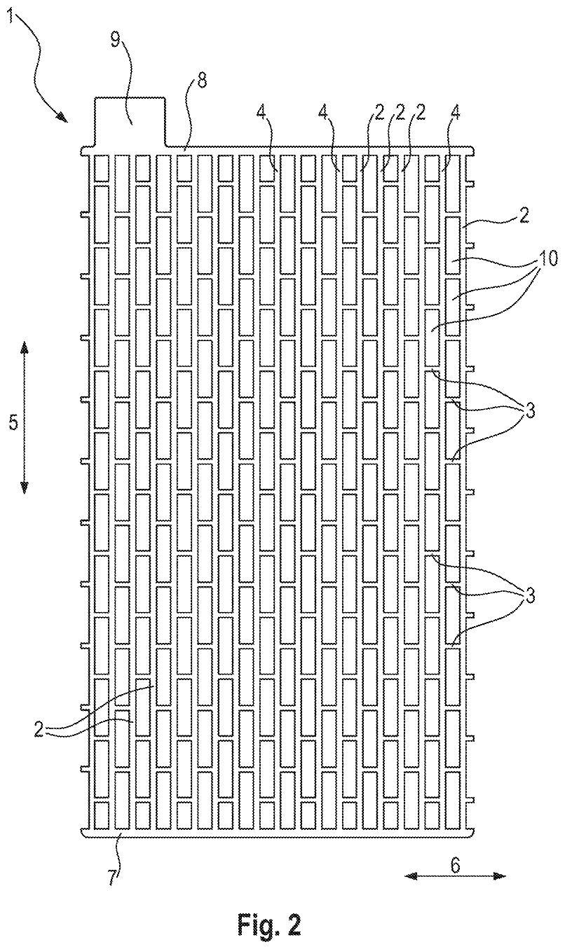

FIG. 2 shows the mesh 1 according to the disclosure in a plan view from the front, wherein it is particularly apparent from this view that the transverse ribs 3 are arranged offset from longitudinal rib 2 or 4 to longitudinal rib 2 or 4 in the longitudinal direction 5. In this manner, there is also produced an offset pattern of the open areas 10.

According to the disclosure, the longitudinal ribs 2 on the one hand and the further longitudinal ribs 4 on the other hand have a different width design in the transverse direction 6. Accordingly, with regard to the width extension in the transverse direction 6, the longitudinal ribs 2 represent a first longitudinal rib type and the second longitudinal ribs 4 represent a second longitudinal rib type.

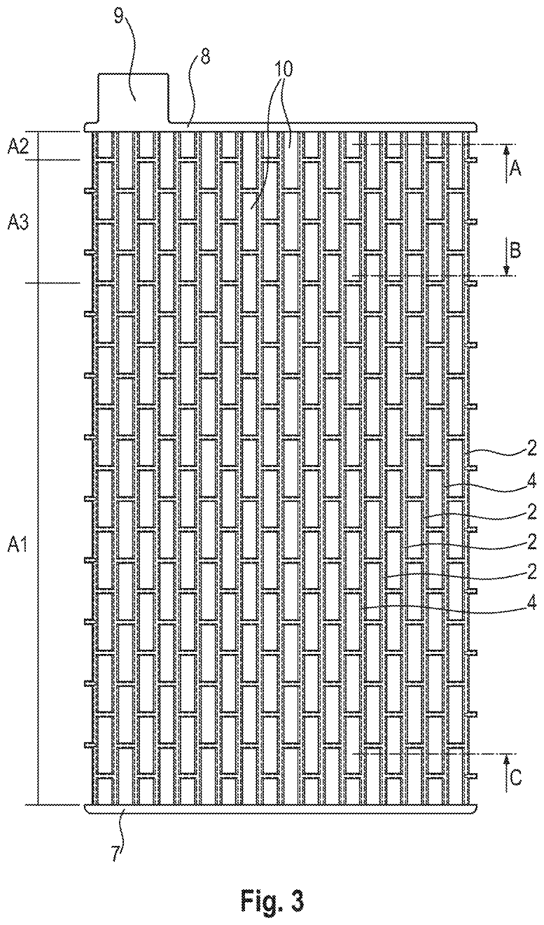

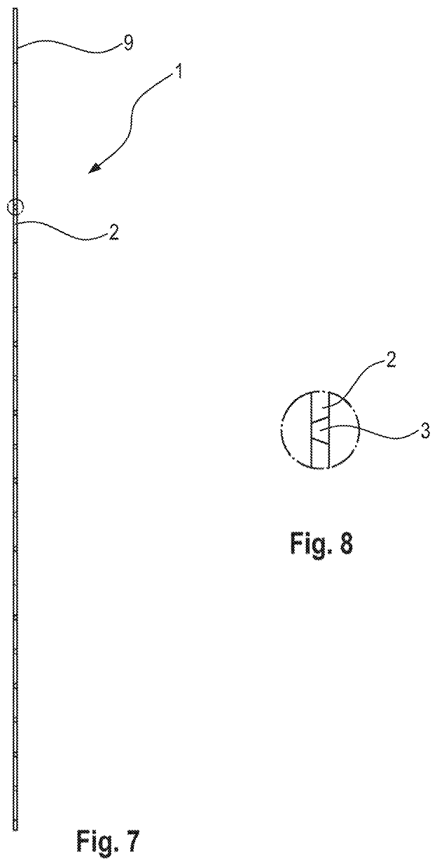

The different design of the longitudinal ribs 2 or 4 is apparent in particular from a combined view of the FIGS. 3 to 8.

As can first be seen from FIG. 3, every fourth longitudinal rib in the transverse direction 6 is formed as a further longitudinal rib 4. All the other longitudinal ribs are longitudinal ribs of the first type, i.e. longitudinal ribs 2. Accordingly, one further longitudinal rib 4 is followed by three longitudinal ribs 2, followed by a further longitudinal rib 4, in turn followed by three longitudinal ribs 2 and so forth.

The longitudinal ribs 2 each have a first section A1, which is followed by the first frame web 7. In the region of this first section A1, the longitudinal ribs 2 each have a first, maximum width B1 in the transverse direction, as can be seen in particular from the sectional view in FIG. 6. This first, maximum width B1 is optimized with regard to the total receiving volume provided by the open areas 10 of the mesh 1 for receiving the active substance. In the illustrated embodiment, this first, maximum width B1 is 1.62 mm.

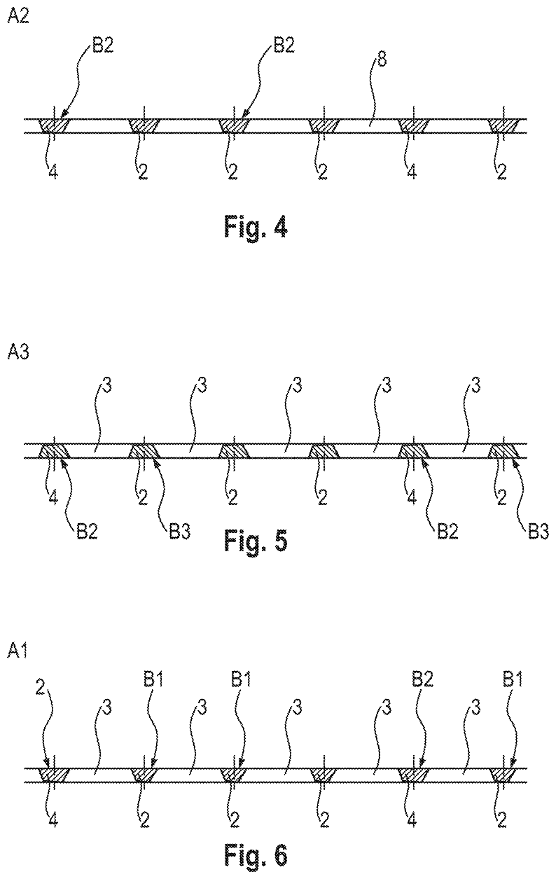

In contrast to the longitudinal ribs 2, the further longitudinal ribs 4 have a second, maximum width B2 in the transverse direction 6 over their entire longitudinal extension, which second width exceeds the first, maximum width B1 of the longitudinal ribs 2. In the illustrated embodiment, this second, maximum width B2 is 2.06 mm, as can be seen from a combination of the sectional views in FIGS. 4, 5 and 6.

The design of the further longitudinal ribs 4, which is reinforced compared to the design of the longitudinal ribs 2, has the positive effect that mesh growth is minimized, which mesh growth occurs as a result of corrosion that cannot be avoided during the use of a mesh for an electrode as intended. The reinforced longitudinal ribs 4 are able to compensate for the force applied in the event of corrosion, which in particular counteracts longitudinal expansion of the mesh 1 in the longitudinal direction 5.

The longitudinal ribs 2 are optimized in their width in the transverse direction 6 for providing a maximized receiving volume for receiving the active substance. In combination, the longitudinal ribs 2 on the one hand and the further longitudinal ribs 4 on the other hand provide a mesh 1 that ensures minimum mesh growth while providing a maximized receiving volume for receiving the active substance during its use as intended.

According to the preferred embodiment shown in FIGS. 3 to 8, the longitudinal ribs 2 each have a width design in the transverse direction 6 that varies in the longitudinal direction 5. Accordingly, the further two sections A2 and A3 are provided in addition to the above-described section A1. Section A2 of the longitudinal ribs 2 connects to the second frame web 8. The third section A3 represents a transition section between the two sections A1 and A2.

As can be seen especially from the sectional view according to FIG. 4, the longitudinal ribs 2 have a width in the transverse direction in section A2 which corresponds to the second, maximum width B2. Accordingly, the longitudinal ribs 2 have a width in the transverse direction 6 in their current collector-side section A2, which preferably is 2.06 mm. Therefore, the longitudinal ribs 2 and the further longitudinal ribs 4 in the transverse direction 6 are designed equally wide in the region of the second section A2.

The longitudinal ribs 2 continuously taper in width in the transverse direction 6 from section A2 until they reach a third, maximum width B3, as in the sectional view according to FIG. 5, this third, maximum width being smaller in its dimension than the second, maximum width B2, but larger than the first, maximum width B1.

From this width extension according to width B3, the width of the longitudinal ribs 2 in the transverse direction 6 suddenly tapers to the first, maximum width B1 shown in FIG. 6. Accordingly, regarding the longitudinal ribs 2, a continuous, tapering width reduction from width B2 to width B3 is provided overall, followed by a sudden width reduction to the first, maximum width B1.

The mesh 1 is preferably produced in a continuous casting process. For reasons of mold release, the longitudinal ribs 2 or 4 and also the transverse ribs 3 are formed with a trapezoidal cross section, as shown in FIGS. 4, 5, and 6 for the longitudinal ribs 2 or 4 and in FIG. 8 for the transverse ribs 3.

As FIGS. 4, 5 and 6 also show, “maximum width” in terms of the disclosure means the cross-section point where a longitudinal rib 2 or 4 has the largest dimension in the transverse direction 6. For a trapezoidal cross section, this cross-section point is formed for example at the upper edge of a longitudinal rib 2 or 4 with reference to the drawing plane, the second, maximum width B2 being shown in FIG. 4. For a rectangular cross section, the width extension of a longitudinal rib 2 or 4 in the transverse direction 6 is constant, meaning that it does not taper compared to a trapezoidal cross section, so that for a rectangular cross section the given width in the transverse direction 6 is equal to the maximum width.

The foregoing description of the embodiments has been provided for purposes of illustration and description. It is not intended to be exhaustive or to limit the disclosure. Individual elements or features of a particular embodiment are generally not limited to that particular embodiment, but, where applicable, are inter-changeable and can be used in a selected embodiment, even if not specifically shown or described. The same may also be varied in many ways. Such variations are to be regarded as a departure from the disclosure, and all such modifications are intended to be included within the scope of the disclosure.

1. A mesh for an electrode of a lead-acid battery, having a plurality of longitudinal ribs arranged spaced apart from one another in the transverse direction and having a plurality of transverse ribs arranged between two respective adjacent longitudinal ribs and connected thereto, which longitudinal and transverse ribs form a mesh pattern with open areas for receiving an active substance, wherein the longitudinal ribs have a first maximum width in the transverse direction at least in one section running in the longitudinal direction, which is formed in an optimized manner with respect to the total receiving volume provided by the open areas for receiving the active substance, wherein at least one further longitudinal rib is provided, which has a second, maximum width over its entire longitudinal extent in the transverse direction, said width exceeding the first, maximum width of the other longitudinal ribs.

2. The mesh according to claim 1, wherein the second, maximum width exceeds the first, maximum width by 20% to 35%, preferably by 25% to 30%, even more preferably by 27.5%.

3. The mesh according to claim 1, wherein the first, maximum width is 1.4 mm to 1.8 mm, preferably 1.5 mm to 1.7 mm, even more preferably 1.6 mm.

4. The mesh according to claim 1, wherein the second, maximum width is 1.8 mm to 2.2 mm, preferably 1.9 mm to 2.1 mm, even more preferably 2.0 mm.

5. The mesh according to claim 1, wherein a plurality of further longitudinal ribs with a second, maximum width is provided.

6. The mesh according to claim 5, wherein in the transverse direction every third to fifth, preferably every fourth longitudinal rib is a further rib with a second, maximum width in the transverse direction.

7. The mesh according to claim 1, wherein the longitudinal ribs have a width in the transverse direction in a second section running in the longitudinal direction, which width corresponds to the second, maximum width of the further longitudinal rib.

8. The mesh according to claim 7, wherein the longitudinal ribs have a width in the transverse direction in a third section running in the longitudinal direction between the second and the first section, which continuously tapers from the second, maximum width to a third, maximum width.

9. The mesh according to claim 1, wherein the longitudinal ribs and the further longitudinal rib extend between a first frame web and a second frame web, with which they are respectively integrally connected, wherein the second frame web carries a current collector lug.

10. The mesh according to claim 9, wherein the second section of the longitudinal ribs merges into the second frame web and the first sections of the longitudinal ribs merge into the first frame web.

11. The mesh according to claim 1, wherein the same is produced in a continuous casting process.

12. The mesh according to claim 11, wherein the longitudinal ribs as well as the further longitudinal rib each have a trapezoidal cross section.

13. The mesh according to claim 1, wherein the longitudinal ribs as well as the further longitudinal rib each have a rectangular cross section.
